(19) United States
(12) Patent Application Publication
(10) Pub. No.: US 2010/0007934 A1
(43) Pub. Date: Jan. 14, 2010

(54) Optical Element and Image Display Device Using the Same

(75) Inventor: Kei Tokui, Osaka-shi (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/448,932

(22) PCT Filed: Jan. 17, 2008
(86) PCT No.: PCT/JP2008/050488

§ 371 Date: Jul. 14, 2009

(30) Foreign Application Priority Data
Jan. 18, 2007 (JP) 2007-008623

(51) Int. Cl. G02B 27/48; G02B 26/08; G03B 21/00

(52) U.S. Cl. 359/205.1; 359/211.1; 359/209.1

(57) ABSTRACT

An optical element includes a light transmission member 100 having an incident plane 5 on which a light beam is incident and an output plane 7 from which the light beam that was previously incident on the incident plane 5 is output, and an oscillation member 101 adapted to oscillate the light transmission member 100. The light transmission member 100 is a polygonal prism having the incident plane 5 and the output plane 7 that are arranged such that the plane that includes the incident plane intersects the plane that includes the output plane. The oscillation member 101 oscillates the light transmission member in a direction in which the propagation length for which the light beam being previously incident on the light transmission member 100 travels through the light transmission member 100 changes. Accordingly, it is possible to provide an optical element for displaying images with reduced speckled noise in cases in which light sources emit coherent light beams.

### TECHNICAL FIELD

The present invention relates to reducing interference noise by the use of an optical element, and also relates to a technique of improving the image quality of an image display device using such noise reduction.

### BACKGROUND ART

Conventionally, xenon lamps, super-high pressure mercury lamps, and the like have been used as light sources of projection-type image display devices typified by front projectors. A light beam emitted from such a light source is modulated with an optical modulation element such as a DMD (Digital Micromirror Device) or a liquid crystal panel in accordance with an input video signal, and is then magnified and displayed with a rear-stage projection lens.

Image display devices that use LEDs (Light Emitting Diodes) as another kind of light source have also been developed. The emission wavelength spectrum of LED has a steep wavelength spectrum, thus providing high color purity. Thus, LED has a feature that the color reproduction range of an image display device can be wide. Further, in recent years, research of image display devices equipped with laser light sources that have a steeper wavelength spectrum than that of LED has also been advanced. Such a device has a wider color reproduction range than image display devices that use LEDs as light sources, and thus has improved image quality. In addition, such a device has a feature of high light-use efficiency because lasers are closer to point light sources compared to LEDs and have narrow beam divergence angles.

However, laser light sources have been known to easily cause interference because of their high coherence properties. Thus, there is a problem in that if a member having a diffusion function such as a screen is irradiated with light beams emitted from an image display device that uses laser light sources, diffused light beams would mutually interfere with one another, thus generating speckle patterns. Such a phenomenon is called speckle noise, which is considered to be one of the causes of image degradation of an image display device.

As a method of reducing such speckle noise, a method is known that temporally changes the optical path length of a light beam used for displaying an image. For example, a technique disclosed in Patent Document 1 below is known. In Patent Document 1 below, as illustrated in FIG. 7, a light beam emitted from a light source is incident on an image display device, and a light beam modulated as an image is incident on a movable optical component, and then, the light beam is projected onto a screen. The movable optical component has steps (recesses and projections) of about equal to the wavelength. Thus, an optical path difference is generated depending on the beam incident position on the optical component, and optical path difference distribution is temporally changed by driving such an optical component.

For image display devices that use laser light sources, a method of using a mirror as an optical modulation element is known. Light beams emitted from lasers are considered to be substantially linear beams, and a two-dimensional mirror or two pieces of one-dimensional mirrors is/are used to make the laser beams scan, whereby images can be represented. Gradation can be represented through modulation of the laser emission intensity.

### Patent Document 1: JP Patent Publication (Kokai) No. 2002-90881 A

### DISCLOSURE OF THE INVENTION

### Problems to be Solved by the Invention

However, the technique disclosed in Patent Document 1 above and the like have the following problems. In mirror-scanning-type image display devices, laser beams are used for pixels, and thus the optical path of the laser is narrow. Thus, when an optical component having steps (recesses and projections) as described in Patent Document 1 above is applied to a mirror-scanning-type image display device, the area of a portion of the optical component through which a laser beam passes could be small. This means that the time in which a laser beam passes through the same region of the recessed portion or the projecting portion of the optical component could be long, and thus the time in which the optical path length of a laser beam does not change could be long. Accordingly, speckle noise could easily be generated, resulting in degraded image quality.

In order to reduce speckle noise, micromachining of the recessed and projecting patterns down to the size of about equal to the laser spot size is considered. However, this would require a reduction of machining dimensions as well as cost increase associated with the production of optical components such as prolonged machining time and decreased yields. Further, when there are provided only two kinds of optical path lengths that are the optical path length of a laser beam passing through the recessed portion and the optical path length of a laser beam passing through the projecting portion, there will be only a few kinds of speckle patterns to be obtained. This is problematic in that even if quasi-integration is performed in the process of visual observation, the effect of reducing speckle noise could be insufficient.

Further, when a structure is used in which a circular optical component is rotated with a motor, another problem arises in that vibration noise of the motor or wind noise of the optical component could be generated. Therefore, noise could be generated as the image display device, resulting in degraded image quality.

It is an object of the present invention to reduce speckle noise as well as the production cost of optical components.

### Means for Solving the Problems

According to one aspect of the present invention, an optical element is provided that includes a light transmission member having an incident plane on which a light beam is incident and an output plane from which the light beam that was previously incident on the incident plane is output, and an oscillation member adapted to oscillate the light transmission member, wherein the incident plane and the output plane of the light transmission member are arranged such that the plane that includes the incident plane intersects the plane that includes the output plane, and the oscillation member oscillates the light transmission member in a direction in which the propagation length for which the light beam being previously incident on the light transmission member travels through the light transmission member changes. Accordingly, the optical path length of a light beam that enters the optical element can be temporally changed. The light transmission member can be a polygonal prism whose side faces include the incident plane and the output plane. Thus, the production of the light transmission member can be simplified.

In addition, another optical element is provided that includes a first light transmission member having a first incident plane on which a light beam is incident and a first output plane from which the light beam that was previously incident on the first incident plane is output, a second light transmission member having a second incident plane on which the light beam output from the first light transmission member is incident and a second output plane from which the light beam that was previously incident on the second incident plane is output, and an oscillation member adapted to oscillate the first light transmission member, wherein the first incident plane and the first output plane of the first light transmission member are arranged such that the plane that includes the first incident plane intersects the plane that includes the first output plane, the second output plane of the second light transmission member is parallel with the first incident plane, while the second incident plane of the second light transmission member is parallel with the first output plane, and the oscillation member oscillates the first light transmission member in a direction in which the propagation length for which the light beam being previously incident on the first light transmission member travels through the first light transmission member changes.

With the provision of two light transmission members each having an incident plane and an output plane with a predetermined angle, an optical path difference is generated without a change in the optical axis direction of a light beam that enters the optical element.

The oscillation direction of the first light transmission member or the second oscillation member is made parallel with the first output plane and the second incident plane, whereby the optical axis of a light beam that enters the optical element is maintained without being shifted in a position between the first output plane and the second incident plane. Each of the first light transmission member and the second light transmission member can be a polygonal prism whose side faces include the incident plane and the output plane.

Further, an optical element is provided that includes a first light transmission member having a first incident plane on which a light beam is incident and a first output plane from which the light beam that was previously incident on the first incident plane is output, a second light transmission member having a second incident plane on which the light beam output from the first light transmission member is incident and a second output plane from which the light beam that was previously incident on the second incident plane is output, and an oscillation member adapted to oscillate the second light transmission member, wherein the first incident plane and the first output plane of the first light transmission member are arranged such that the plane that includes the first incident plane intersects the plane that includes the first output plane, the second output plane of the second light transmission member is parallel with the first incident plane, while the second incident plane of the second light transmission member is parallel with the first output plane, and the oscillation member oscillates the second light transmission member in a direction in which the propagation length for which the light beam being previously incident on the second light transmission member travels through the second light transmission member changes.

The oscillation direction of the first light transmission member or the second light transmission member is made parallel with the first output plane and the second incident plane, whereby the optical axis of the light beam that enters the optical element is maintained without being shifted in a position between the first output plane and the second incident plane. At least one of the first light transmission member and the second light transmission member can be a polygonal prism whose side faces include the incident plane and the output plane.

According to another aspect of the present invention, an image display device is provided that includes a light source adapted to emit a coherent light beam, the aforementioned optical element adapted to receive the light beam emitted from the light source as the incident light beam, and an optical modulation element adapted to modulate the light beam output from the optical element and display an image. According to the image display device of the present invention, high-quality images with reduced speckle noise can be displayed even when coherent light sources are used.

### EFFECT OF THE INVENTION

According to an optical element of the present invention, a light transmission member having an incident plane and an output plane, which are arranged such that the plane that includes the incident plane intersects the plane that includes the output plane, is oscillated, whereby the optical path length of a light beam that enters the optical element is temporally changed. Thus, speckle noise can be reduced. Further, since large components such as motors are not used, reduction in size of the device is possible.

Another optical element of the present invention includes a first light transmission member having an incident plane and an output plane, which are arranged such that the plane that includes the incident plane intersects the plane that includes the output plane, and a second light transmission member having an incident plane and an output plane, which are arranged such that the plane that includes the incident plane intersects the plane that includes the output plane. The first light transmission member or the second light transmission member is oscillated, whereby speckle noise can be reduced. In addition, since the traveling direction of a light beam incident on the first light transmission member is parallel with the traveling direction of a light beam output from the second light transmission member, an optical system that includes the optical element of the present invention can be constructed with a simple structure.

According to the image display device of the present invention, high-quality images with reduced speckle noise can be displayed even when coherent light sources are used.

### BRIEF DESCRIPTION OF THE DRAWINGS

FIG. 1 is a perspective view illustrating an exemplary schematic structure of an optical element in accordance with the first embodiment of the present invention.

FIG. 2 are views each illustrating an exemplary schematic structure of the optical element in accordance with the present embodiment.

FIG. 3 is a view illustrating a state of an optical element in accordance with the second embodiment of the present invention.

FIG. 4 is a view illustrating a state of the optical element in accordance with the present embodiment.

FIG. 5 is a view illustrating an example in which a prism is held.

FIG. 6 is a view illustrating an exemplary schematic structure of an image display device in accordance with the third embodiment of the present invention.

FIG. 7 is a view illustrating a conventional technique.

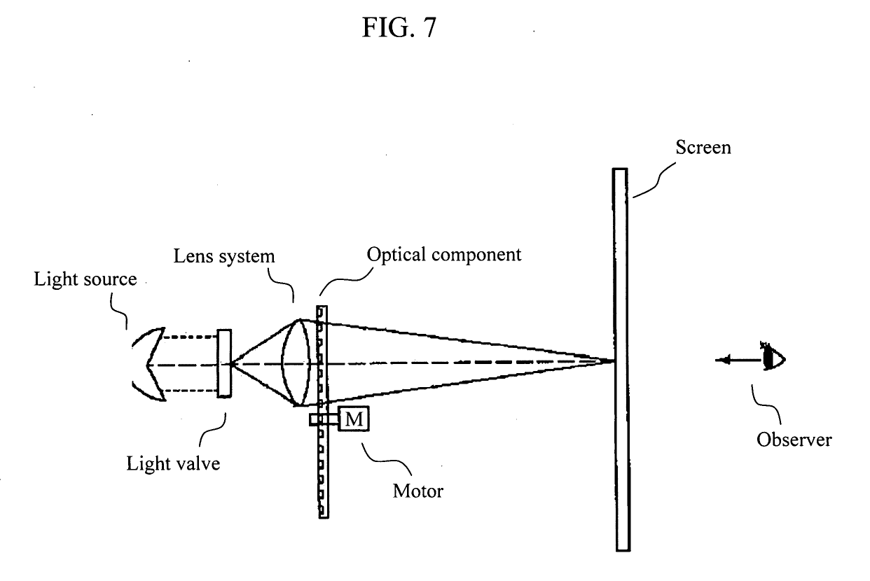

### DESCRIPTION OF SYMBOLS

100 . . . prism, 101 . . . actuator, 200 . . . prism, 201 . . . prism, 202 . . . spring, 203 . . . guide, 300 . . . red laser, 301 . . . green laser, 302 . . . blue laser, 303 . . . total reflection mirror, 304 . . . dichroic mirror, 305 . . . dichroic mirror, 306 . . . movable mirror, 307 . . . movable mirror

### BEST MODES FOR CARRYING OUT THE INVENTION

Hereinafter, an optical element and an image display device using the same in accordance with the embodiments of the present invention will be described with reference to the drawings. It should be noted that the structure illustrated in each of the drawings is partly shown with exaggeration for the sake of easier understanding of the invention, and there may be cases in which the distance between some components or the size of such components does not correspond to the actual distance or size.

First, the first embodiment of the present invention will be described.

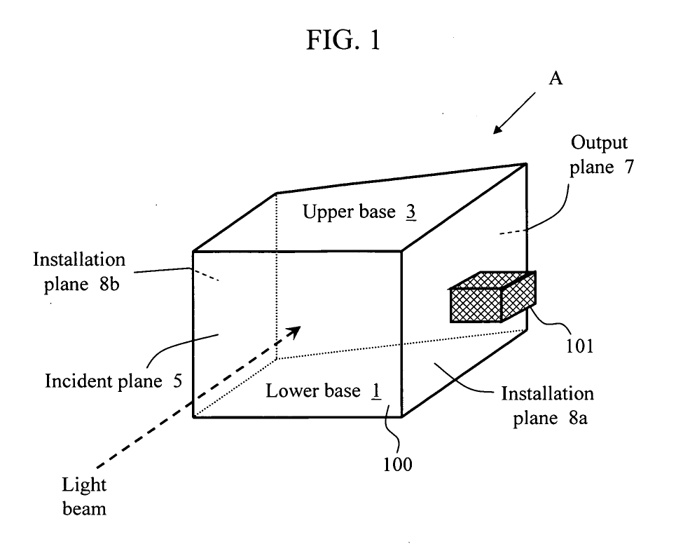

FIG. 1 is a perspective view illustrating an exemplary schematic structure of a light transmission member in accordance with the present embodiment. A quadrangular prism 100 made of glass, for example, and having a lower base 1 that is trapezoidal in shape, for example, is used as a light transmission member of an optical element A of the present embodiment. An actuator 101 capable of causing displacement (positional change of the light transmission member) with a voltage applied is disposed as an oscillation member, for the prism 100.

A light beam 11 that is to enter the optical element A is adapted to be perpendicularly incident on an incident plane 5 of the prism 100. The light beam 11 that enters the prism 100 propagates through the prism 100, and then is output from an output plane 7 positioned opposite the incident plane 5. The actuator 101 is disposed on a plane other than the incident plane 5, the output plane 7, the lower base 1, and an upper base 3 of the prism 100 (although FIG. 1 illustrates an example in which the actuator 101 is disposed on an installation plane 8a, it can also be disposed on an installation plane 8b).

This is because, if the actuator 101 is disposed on the incident plane 5 and the output plane 7, the position of the prism 100 will change upon oscillation of the actuator, whereas the incident position and output position of a light beam on the prism 100 will not change. Thus, the length for which the light beam propagates through the prism 100 will not change. Meanwhile, if the actuator 101 is disposed on the lower base 1 and the upper base 3, the incident position and output position of a light beam will change, whereas the length for which the light beam propagates through the prism 100 will not change because the prism 100 is a quadrangular prism, which means that the prism 100 will be displaced in a direction parallel with the incident plane and the output plane. Thus, when the actuator 101 is disposed on the plane illustrated in FIG. 1, the length of a light beam can be changed as described below.

Force generated by the actuator 101 is adapted to be directly or indirectly transmitted to the prism 100 via a mechanical component, for example. Thus, the prism 100 is oscillated by repeatedly expanding and contracting the actuator 101.

Although the light transmission member (prism) 100 in the aforementioned example has the shape of a stereoscopic quadrangular prism (a polygonal prism), the actual requirements for the light transmission member 100 are the two following: the incident plane and the output plane of the light transmission member be not parallel with each other, and the light transmission member be oscillated in a direction in which the propagation length for which a light beam travels through the light transmission member changes. Thus, the embodiment of FIG. 1 is illustrated as one example that meets such requirements.

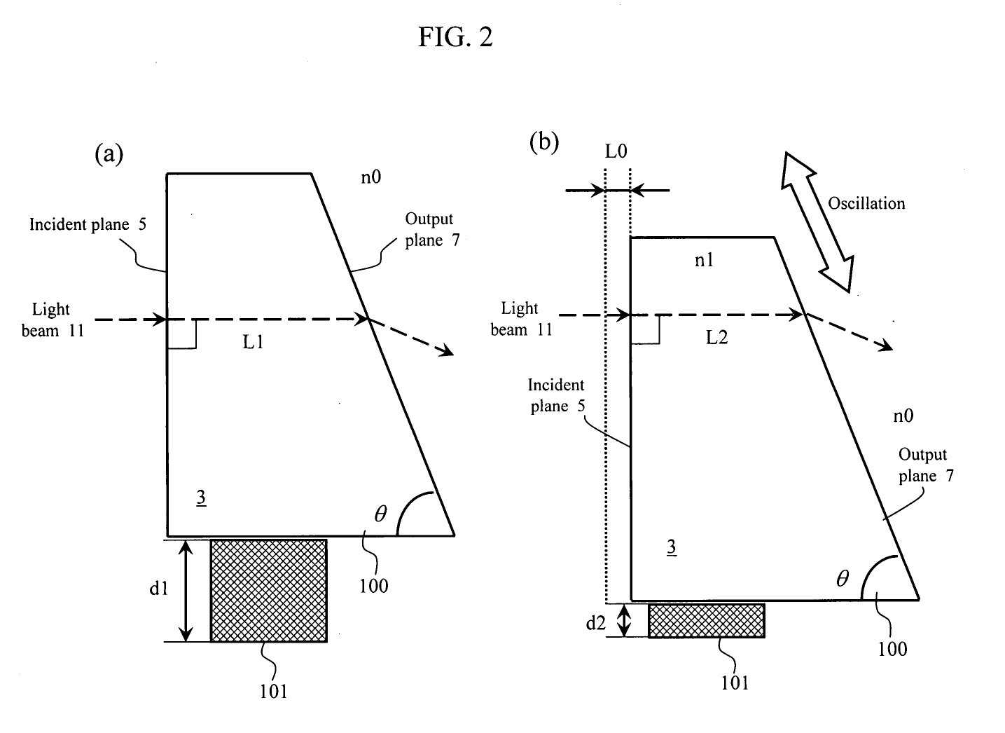

FIG. 2(a) is a top view of the structure of FIG. 1. The actuator 101 is put into a state of a length of d1 by a voltage. At this time, the light beam 11 incident on the incident plane 5 of the prism 100 travels by a length of L1, and then is output from the output plane.

FIG. 2(b) is a view illustrating the state of the actuator 101 that has changed from the state of FIG. 2(a) and has a length of d2. As shown by the hollow arrow, oscillation along the output plane 7 is generated, whereby the abutment plane of the actuator 101 moves toward the actuator 101 by a distance of d1-d2 in FIG. 2(b). The prism 100 is displaced in a direction parallel with the output plane 7 so that the output light beam will not change. At this time, the length for which the light beam travels through the prism 100 is L2. Thus, the position of the incident plane is displaced by a distance of L0, from the state of FIG. 2(a) to the state of FIG. 2(b).

Here, provided that the refractive index of the prism 100 is n1, the refractive index of air is n0, and the acute angle of the base of the prism 100 is θ, the optical path difference L generated between the states of FIG. 2(a) and FIG. 2(b) is given by the following Formula (1).

$$\begin{matrix}L = ( L 0 / n 0 + L 2 / n 1 ) - ( L 1 / n 1 ) \\ = [ \begin{matrix}( d 1 - d 2 ) / n 0 \cdot tan θ + \\ \{ L 1 - ( d 1 - d 2 ) / tan θ \} / n 1\end{matrix} ] - ( L 1 / n 1 ) \\ = ( d 1 - d 2 ) \cdot ( 1 / n 0 - 1 / n 1 ) / tan θ\end{matrix} \qquad ( 1 )$$

Thus, with the displacement of the prism 100 by the actuator 101, the optical path difference L is generated. Here, when the angle θ satisfies the following Formula (2), total reflection occurs in the prism 100. Thus, 0 should be an angle that satisfies the following Formula (3).

cos θ≧n0/n1 (2)

cos θ<n0/n1 (3)

For example, provided that the refractive index n1 of the prism 100 is 1.5 and the refractive index n0 of air is 1.0, one can see that θ should be a value greater than 48.19°. Under such conditions, if the angle θ is 60° and the displacement d1-d2 is 1 mm, the optical path difference L generated will be 0.19 mm. According to such a value, it can be seen that an optical path difference that is greater than or equal to 200 times as large as the wavelength (several hundred nanometers) of light can be generated. Thus, since a large optical path difference can be obtained even when there is a small displacement, reduction in size of the device is possible. In addition, the displacement d1-d2 of the actuator 101 for generating an optical path difference of about equal to the wavelength (about 1 μm) is 1.86 μm. The optical path difference can be increased by increasing the refractive index n1, and can also be increased by decreasing the angle θ in a region in which no total reflection occurs.

With the aforementioned structure, the optical path lengths of light beams are constantly changed by repeatedly expanding and contracting the actuator 101, whereby speckle patterns can also be constantly changed, and speckle noise can be reduced by integrating such speckle patterns. In addition, the actuator 101 for causing displacement can be as small as several μm in size in order to generate an optical path difference of about equal to the wavelength. Thus, an optical element that generates an optical path difference can be easily built.

Further, when the actuator 101 is driven at a specific frequency, the actuator will be constantly displaced, and in accordance with such displacement, the optical path difference will also be constantly changed. Thus, speckle patterns will be constantly changed. That is, speckle noise can be reduced by integrating an infinite number of such speckle patterns. In addition, even when the prism 100 is displaced in a direction parallel with the output plane, a light beam output from the optical element will not change with the displacement of the prism 100. Thus, the design of the optical system can be simplified. In the meanwhile, if the prism 100 is displaced in a direction parallel with the incident plane, the output position of a light beam on the output plane will change, which could cause minute displacement of the optical path. However, the output direction of the light beam will not be changed by such displacement. That is, output light beams at given two points of the prism 100 will be parallel with each other. Thus, when the prism 100 is displaced in a direction different than the direction parallel with the output plane, it is possible to construct an optics system capable of reducing speckle noise by designing the optics system such that it can accommodate minute displacement.

Although this embodiment has illustrated an example in which the light transmission member is the prism 100 made of glass, any transmissive material having a refractive index different than that of air can be used. For example, acrylic, polycarbonate, or the like can be used.

In addition, although description has been made of an example in which the shape of the prism 100 is a quadrangular prism with a trapezoidal base, even when a different polygonal prism such as a triangular prism or a pentagonal prism is used, similar effects can be obtained by oscillating the light transmission member having an incident plane and an output plane that are arranged such that the plane that includes the incident plane intersects the plane that includes the output plane. Such a point has been described above.

Although this embodiment has illustrated an example in which the actuator 101 that generates force with a voltage applied is used as the oscillation member, any structure with which displacement can be transmitted to the light transmission member can be used. For example, similar effects can be obtained even when a structure is used in which displacement is caused by other elements such as magnetic force, for example.

Although this embodiment has illustrated an example in which the number of incident light beams is one, similar effects can be obtained even when multiple light beams are concurrently allowed to become incident on the light transmission member. In addition, with regard to light beams that are not totally reflected by the output plane of the transmission member, similar effects can be obtained even when multiple light beams are allowed to become incident on the incident plane at a given angle.

Next, the second embodiment of the present invention will be described with reference to the drawings. In the drawings, portions having similar functions to those of the first embodiment are denoted by the same reference numerals, and description thereof will be omitted.

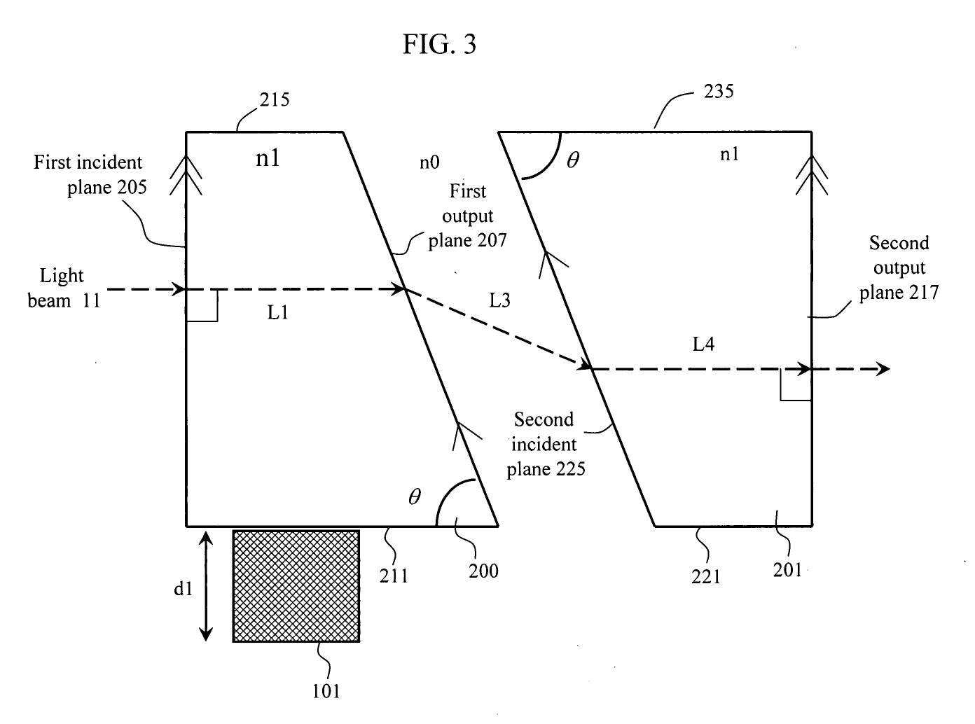

FIG. 3 is a view illustrating an exemplary structure of an optical element in accordance with the present embodiment. As illustrated in FIG. 3, in this embodiment, a prism 200 is provided as a first light transmission member and a prism 201 is provided as a second light transmission member. Each of the prism 200 and the prism 201 can be similar to the prism 100 of the first embodiment. For the oscillation member 101, the actuator 101 similar to that of the first embodiment can be used. The relationship between the prism 200 and the actuator 101 is structured in a similar manner to the relationship between the prism 100 and the actuator 101 in the first embodiment.

The actuator 101 is disposed in the direction of the normal to the plane on which the actuator 101 abuts the base plane 211 of the prism 200, and has a length of d1. A light beam 11 that is to enter the optical element is perpendicularly incident on a first incident plane 205 of the prism 200, and travels through the prism 200 by a distance of L1, and then is output from a first output plane 207. The output light beam travels through air by a distance of L3, and then enters the prism 201 through a second incident plane 225. The incident light beam travels through the prism 201 by a distance of L4, and then is output from a second output plane 217.

Since the first output plane 207 and the second incident plane 225 are disposed in parallel with each other and the first incident plane 205 and the second output plane 217 are disposed in parallel with each other, a light beam that is perpendicularly incident on the first incident plane 205 is output perpendicularly from the second output plane 217. Thus, even when a light beam enters the optical element of this embodiment, the optical axis direction thereof will not change. That is, when the optical element of this embodiment is built into an optical system, an optical component on which a light beam output from the optical element will be incident does not need to be tilted in a complicated way, and there is no need to arrange a mirror for adjusting the optical axis direction, either. Thus, an advantage can be provided in that the optical design can be simplified.

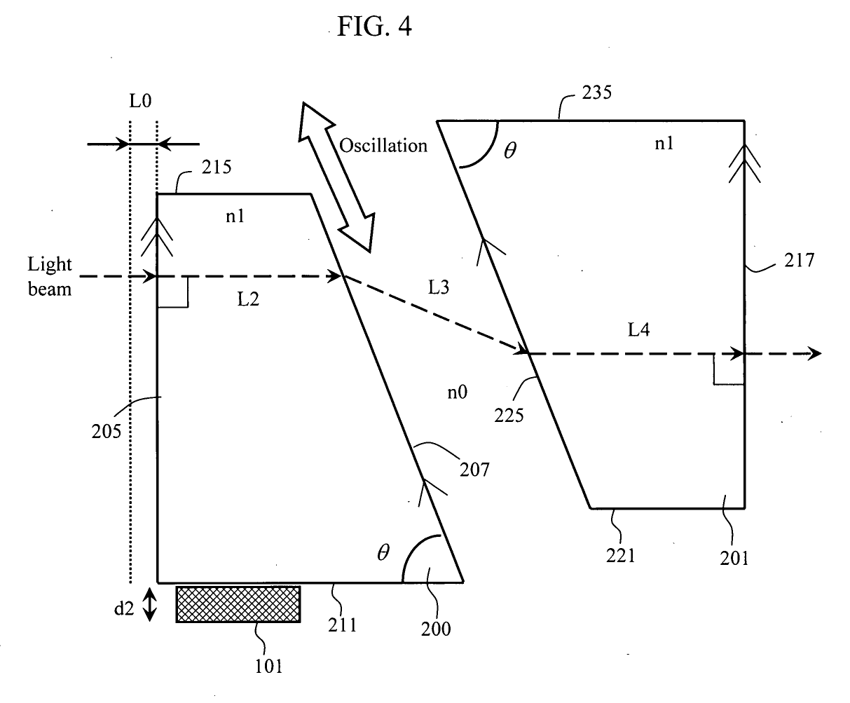

FIG. 4 is a view corresponding to FIG. 3 and illustrating the state of the actuator 101 having a length of d2. Oscillation as shown by the hollow arrow is generated with the displacement of the actuator 101, whereby the prism 200 is also displaced. That is, the prism 200 is displaced such that the position at which a light beam that has propagated through the prism 200 is output from the first output plane 207 remains unchanged. Thus, the prism 200 is oscillated in a similar manner to the prism 100 of the first embodiment.

Since the position at which the light beam is output from the first output plane 207 is unchanged, the propagation path of the light beam after being output from the prism 200 will not change, and the light beam travels through air by a distance of L3, and then through the prism 201 by a distance of L4. That is, the optical path difference between FIG. 3 and FIG. 4 has the same amount of the optical path difference as shown in the first embodiment. Thus, with the optical element of this embodiment, an optical path difference can be generated without a change in the traveling direction of a light beam, whereby speckle noise can be reduced.

Although this embodiment has illustrated a structure in which speckle noise is reduced by oscillating the prism 200, similar operational effects can be obtained even when the prism 201 is oscillated with the prism 200 unmoved, or even when both the prism 200 and the prism 201 are oscillated. In addition, although this embodiment has illustrated an example in which the prism 200 is oscillated in a direction parallel with the first output plane 207, the prism 200 can be oscillated in any direction as long as the propagation length for which a light beam travels through the prism 200 changes. For example, when the prism 200 is oscillated in a direction parallel with the first incident plane 205, the optical path difference L0 will not be generated but an optical path L3 will change. In this manner, the position in which the optical path length changes differs. However, with the optical path difference changed with the optical element, it is still possible to reduce speckle noise. When L3 changes, displacement will also occur in a direction perpendicular to the optical axis direction of the incident light beam. However, such displacement in the perpendicular direction can be suppressed small by disposing the prism 200 and the prism 201 such that they are closely spaced with an air gap therebetween. In addition, since the optical element of this embodiment does not change the optical axis direction, the optical system may be shifted in advance by the amount of displacement in the perpendicular direction on each of the incident side and the output side. Thus, it is possible to construct an optical system capable of reducing speckle noise with simple optics system.

This embodiment has illustrated an example in which a light beam is perpendicularly incident on the first incident plane. When the angle of incidence is other than 0°, the angle of emergence on the second output plane will be equal to the angle of incidence on the first incident plane as long as the angle of incidence is not the angle that could cause total reflection on the second output plane. Thus, speckle noise can be similarly reduced when the angle of incidence is other than 0°. In addition, since the traveling direction of a light beam does not change, the structure of the optics system can be simplified.

Although this embodiment has illustrated an example in which the prism 200 and the prism 201 are identical prisms, similar effects can be obtained even when prisms with different shapes are used. For example, even when the distance between the base plane 211 and a plane 215 that is opposite the base plane 211 changes, similar effects can be obtained. Further, even when the distance between the first incident plane of the prism 200 and the second incident plane changes, for example, similar effects can be obtained. However, the prism 200 and the prism 201 being identical in shape are advantageous in terms of reduction of cost for structural members, simplicity of assembly, and management of components that would be realized by the mass production effect.

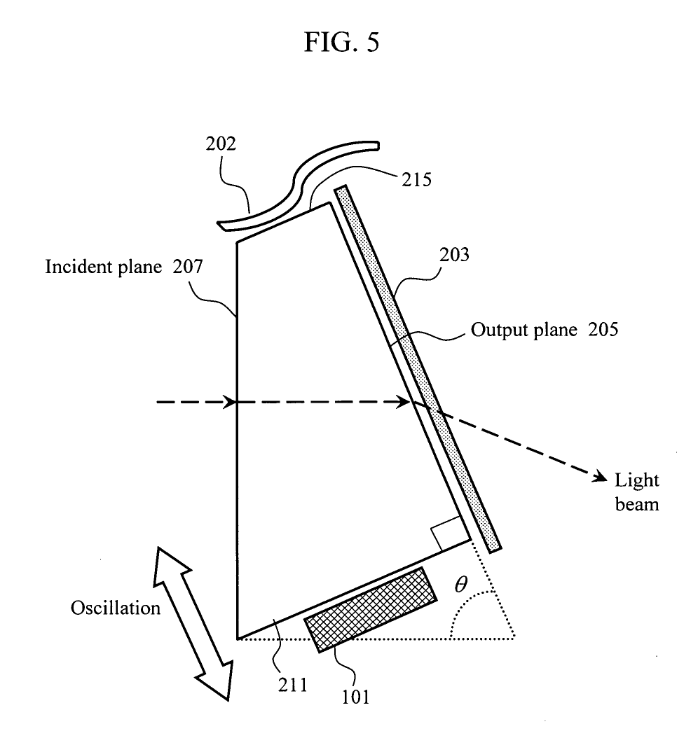

FIG. 5 is a view illustrating an exemplary method of holding the prism being oscillated in accordance with the first and second embodiments. The prism 201 has planes 211 and 215 that are perpendicular to the oscillation direction shown by the hollow arrow. The actuator 101 is disposed in a position in which the actuator 101 abuts the plane 211 that is perpendicular to the oscillation direction. Accordingly, force generated by the actuator 101 can be easily transmitted as the force in the oscillation direction to the prism 201, whereby friction generated by force that acts in directions other than the oscillation direction can be reduced, and thus the power consumption of the actuator 101 can be reduced.

An elastic spring 202 is provided as a repulsion member on the plane 215 that is opposite the plane 211 on which the actuator 101 of the prism 201 is disposed. The spring 202 is disposed in a position in which the spring 202 is made to abut the prism 201 by the movement of the prism 201 in the direction of the spring 202. Upon abutment of the spring 202 on the prism 201, the spring 202 will apply repulsion, which acts in a direction opposite from the force transmitted to the prism 201 by the actuator 101, to the prism 201. The spring 202 contracts in a state in which the actuator 101 is pushing the prism 201 out in the direction of the spring 202. When the operation of the actuator 101 for pushing the prism 201 out in the direction of the spring 202 stops (when the repulsion of the spring 202 becomes greater than the pushing force), the spring 202 will expand with the restoration of elasticity, whereby the prism 201 will be pushed out in the direction of the actuator 101.

The aforementioned structure eliminates the need for an intermediate member that would otherwise be required to transmit the force of the actuator 101 or the need for connecting the actuator 101 to the prism 201. That is, the prism 201 can be oscillated smoothly and stably without the need for complex structural members. The spring 202 can also be a member that has a function of pushing the prism 201 back. For example, when a member made of resin such as elastic rubber is disposed in a position similar to the position of the spring 202, similar effects can be obtained based on a similar action to the aforementioned action.

The output plane 205 of the prism 201 can be arbitrarily provided with a guide member 203 in such a position (region) that output light beams are not blocked. The guide member 203 is arranged to be substantially parallel with the oscillation direction of the prism 201. The provision of the guide member 203 is advantageous because it will assist in causing stable and smooth displacement of the prism 201 in the oscillation direction.

Next, the third embodiment of the present invention will be described with reference to the drawings. It should be noted that portions having similar functions to those of the first and second embodiments are denoted by the same reference numerals, and description thereof will be omitted.

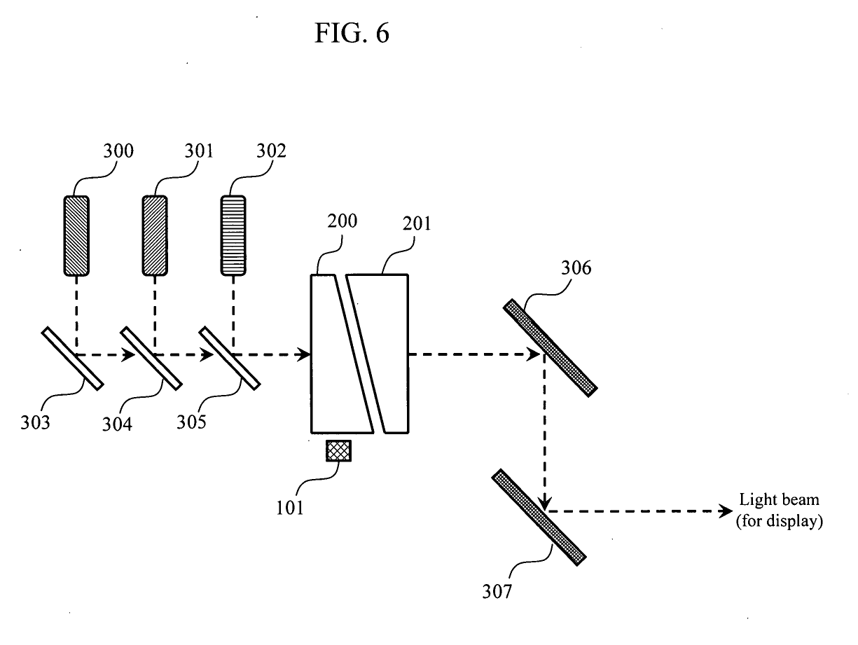

FIG. 6 is a view illustrating an exemplary schematic structure of an image display device in accordance with the present embodiment. As light sources, a red laser 300 that emits coherent light beams with the emission wavelength in the red wavelength range, a green laser 301 that emits coherent light beams with the emission wavelength in the green wavelength range, and a blue laser 302 that emits coherent light beams with the emission wavelength in the blue wavelength range are provided. As the lasers, semiconductor lasers, gas lasers, lasers that utilize SHG (Second Harmonic Generation) light, and the like can be appropriately used. Gradation can be controlled by changing the output of each laser or by using an acousto-optic device or the like.

An optical modulation element includes a movable mirror 306 and a movable mirror 307. The movable mirror 306 performs horizontal scanning and the movable mirror 307 performs vertical scanning. For the movable mirror 306 and the movable mirror 307, piezoelectric mirrors, galvanometer mirrors, and the like can be used in accordance with the operating frequency.

A light beam emitted by the red laser 300 is reflected by a total reflection mirror 303 having silver, aluminum, or a dielectric multilayer as a reflecting surface. A light beam emitted by the green laser 301 is reflected by a dichroic mirror 304 having a dielectric multilayer as a reflecting surface. The dichroic mirror 304 is adapted to reflect light beams in the green wavelength range and transmit light beams in the red wavelength range. Accordingly, the red light beam reflected by the total reflection mirror 303 passes through the dichroic mirror 304, and the red and green light beams propagate along the substantially same optical path. A light beam emitted by the blue laser 302 is reflected by a dichroic mirror 305 having a dielectric multilayer as a reflecting surface. The dichroic mirror 305 is adapted to reflect light beams in the blue wavelength range and transmit light beams in the red and green wavelength ranges. Accordingly, the red and green light beams propagated from the dichroic mirror 304 pass through the dichroic mirror 305, and the red, green, and blue light beams propagate along the substantially same optical path.

The light beam propagated from the dichroic mirror 305 is incident on the optical element illustrated in the second embodiment. A light beam that has entered the first prism 200 is subjected to a temporal change in the optical path length by the actuator 101 and then is output from the first prism 200. The light beam output from the second prism 201, which is disposed adjacent to the first prism 200 in a position rotated by an angle of 180° with respect to the first prism 200 on the plane of paper, has the same optical axis direction as the light beam that was previously incident on the first prism 200. Then, the light beam is incident on the movable mirror 306. The movable mirror 306 makes the incident light beam scan horizontally, and the movable mirror 307 makes the light beam that has been made to scan horizontally scan vertically, so that a color image is formed.

In the image display device of this embodiment, a light beam to be projected passes through the optical element of the second embodiment. Thus, the optical path length for which a light beam travels from the light sources to a screen (not shown) temporally changes. Thus, speckle noise can be reduced by integrating a large number of speckle patterns. That is, even when laser light sources with high color purity are used in order to construct an image display device with a wide color reproduction range, speckle noise can be reduced, and thus, an image display device with high image quality can be provided.

This embodiment has illustrated an example in which the two movable mirrors 306 and 307 are used as the optical modulation element. However, it is also possible to use a two-dimensional movable mirror capable of two-axis scanning in the horizontal and vertical directions, and it is also possible to use a pixel-type display element such as a DMD or a liquid crystal panel. Further, the image display device of this embodiment can be applied not only to front projectors or rear projectors but also to measuring instruments, manufacturing apparatuses, and the like that use coherent light sources.

As described above, according to the optical element of each of the embodiments of the present invention, a polygonal prism, for example, that has an incident plane and an output plane, which are arranged such that the plane that includes the incident plane intersects the plane that includes the output plane, is oscillated, whereby the optical path length of a light beam that enters the optical element is temporally changed, and thus, speckle noise can be reduced.

According to the optical element of this embodiment, two light transmission members each having an incident plane and an output plane with a predetermined angle are provided, whereby an optical path difference can be generated without a change in the optical axis direction of a light beam that enters the optical element, and thus, speckle noise can be reduced.

In addition, according to the optical element of this embodiment, a light beam is perpendicularly incident on the first incident plane, whereby the light beam is output perpendicularly from the second output plane. Thus, the structure of an optical system that uses the optical element can be simplified.

According to the optical element of this embodiment, the oscillation direction of the first light transmission member or the second light transmission member is made parallel with the first output plane and the second incident plane, whereby the optical axis of a light beam that enters the optical element can be maintained without being shifted in a position between the first output plane and the second incident plane. Thus, the structure of an optical system that uses the optical element can be simplified.

In addition, according to the optical element of this embodiment, when the same members are used for the first light transmission member and the second light transmission member, the kinds of structural members included in the optical element can be reduced, and thus, the cost of the optical element can be reduced by the mass production effect resulting from the production of multiple identical members.

Further, according to the optical element of this embodiment, the oscillation member is disposed on a plane perpendicular to the oscillation direction, whereby force can be more easily transmitted to the light transmission member, the first light transmission member, or the second light transmission member to be oscillated. Thus, the force generated by the oscillation member can be suppressed small, and the power consumption can thus be reduced.

In addition, according to the optical element of this embodiment, the light transmission member, the first light transmission member, or the second light transmission member to be oscillated can be adapted to be more easily oscillated in a fixed direction by means of a guide. Thus, stable operation of the optical element is possible.

Furthermore, according to the optical element of this embodiment, the force of a repulsion member is applied such that the light transmission member will move in a direction opposite from the moving direction thereof by the oscillation member. Thus, the oscillation of the light transmission member, the first light transmission member, or the second light transmission member can be stabilized, and thus, stable operation of the optical element is possible.

According to an image display device that uses the aforementioned optical element, high-quality images with reduced speckle noise can be displayed even when coherent light sources are used.

### INDUSTRIAL APPLICABILITY

The present invention is applicable to optical elements and image display devices.

1. An optical element comprising:
a light transmission member having an incident plane on which a light beam is incident and an output plane from which the light beam that was previously incident on the incident plane is output; and
an oscillation member adapted to oscillate the light transmission member,
wherein:
the incident plane and the output plane of the light transmission member are arranged such that the plane that includes the incident plane intersects the plane that includes the output plane, and
the oscillation member oscillates the light transmission member in a direction in which the propagation length for which the light beam being previously incident on the light transmission member travels through the light transmission member changes.

2. An optical element comprising:
a first light transmission member having a first incident plane on which a light beam is incident and a first output plane from which the light beam that was previously incident on the first incident plane is output;
a second light transmission member having a second incident plane on which the light beam output from the first light transmission member is incident and a second output plane from which the light beam that was previously incident on the second incident plane is output; and
an oscillation member adapted to oscillate the first light transmission member,
wherein:
the first incident plane and the first output plane of the first light transmission member are arranged such that the plane that includes the first incident plane intersects the plane that includes the first output plane,
the second output plane of the second light transmission member is parallel with the first incident plane, and the second incident plane of the second light transmission member is parallel with the first output plane, and
the oscillation member oscillates the first light transmission member in a direction in which the propagation length for which the light beam being previously incident on the first light transmission member travels through the first light transmission member changes.

3. An optical element comprising:
a first light transmission member having a first incident plane on which a light beam is incident and a first output plane from which the light beam that was previously incident on the first incident plane is output;
a second light transmission member having a second incident plane on which the light beam output from the first light transmission member is incident and a second output plane from which the light beam that was previously incident on the second incident plane is output; and
an oscillation member adapted to oscillate the second light transmission member,
wherein:
the first incident plane and the first output plane of the first light transmission member are arranged such that the plane that includes the first incident plane intersects the plane that includes the first output plane,
the second output plane of the second light transmission member is parallel with the first incident plane, and the second incident plane of the second light transmission member is parallel with the first output plane, and
the oscillation member oscillates the second light transmission member in a direction in which the propagation length for which the light beam being previously incident on the second light transmission member travels through the second light transmission member changes.

4. An image display device comprising:
a light source adapted to emit a coherent light beam;
the optical element as recited in any one of claims 1 to 3, the optical element being adapted to receive the light beam from the light source as the incident light beam; and
an optical modulation element adapted to modulate the light beam output from the optical element and display an image.

5. An optical unit comprising:
a first light transmission member having a first incident plane on which a light beam is incident, a first output plane from which the light beam that was previously incident on the first incident plane is output, and a plane perpendicular to the first output plane;
a second light transmission member having a second incident plane on which the light beam output from the first light transmission member is incident and a second output plane from which the light beam that was previously incident on the second incident plane is output; and
an oscillation member adapted to oscillate the first light transmission member,
wherein the oscillation member is disposed on the plane perpendicular to the first output plane, and the first light transmission member is oscillated in a direction parallel with the first output plane.

6. An optical unit comprising:
a first light transmission member having a first incident plane on which a light beam is incident and a first output plane from which the light beam that was previously incident on the first incident plane is output;
a second light transmission member having a second incident plane on which the light beam output from the first light transmission member is incident, a second output plane from which the light beam that was previously incident on the second incident plane is output, and a plane perpendicular to the second incident plane; and
an oscillation member adapted to oscillate the second light transmission member,
wherein the oscillation member is disposed on the plane perpendicular to the second incident plane, and the second light transmission member is oscillated in a direction parallel with the second incident plane.

7. An image display device comprising:
a light source adapted to emit a coherent light beam;
the optical element as recited in claim 5 or 6, the optical element being adapted to receive the light beam from the light source as the incident light beam; and
an optical modulation element adapted to modulate the light beam emitted from the light source and display an image.

8. An optical element comprising:
a light transmission member having an incident plane on which a light beam is incident and an output plane from which the light beam that was previously incident on the incident plane is output; and
an oscillation member adapted to oscillate the light transmission member,
wherein:
the incident plane and the output plane of the light transmission member are arranged such that the plane that includes the incident plane intersects the plane that includes the output plane,
the oscillation member oscillates the light transmission member in a direction in which the propagation length for which the light beam being previously incident on the light transmission member travels through the light transmission member changes, and
a guide is arranged to be parallel with the oscillation direction of the light transmission member.

9. An optical element comprising:
a first light transmission member having a first incident plane on which a light beam is incident and a first output plane from which the light beam that was previously incident on the first incident plane is output;
a second light transmission member having a second incident plane on which the light beam output from the first light transmission member is incident and a second output plane from which the light beam that was previously incident on the second incident plane is output; and
an oscillation member adapted to oscillate the first light transmission member,
wherein:
the first incident plane and the first output plane are arranged such that the plane that includes the first incident plane intersects the plane that includes the first output plane,
the second incident plane and the second output plane are arranged such that the plane that includes the second incident plane intersects the plane that includes the second output plane,
the oscillation member oscillates the first light transmission member in a direction in which the propagation length for which the light beam being previously incident on the first light transmission member travels through the first light transmission member changes, and
a guide is arranged to be parallel with the oscillation direction of the first light transmission member.

10. An optical element comprising:
a first light transmission member having a first incident plane on which a light beam is incident and a first output plane from which the light beam that was previously incident on the first incident plane is output;
a second light transmission member having a second incident plane on which the light beam output from the first light transmission member is incident and a second output plane from which the light beam that was previously incident on the second incident plane is output; and
an oscillation member adapted to oscillate the second light transmission member,
wherein:
the first incident plane and the first output plane are arranged such that the plane that includes the first incident plane intersects the plane that includes the first output plane,
the second incident plane and the first output plane are arranged such that the plane that includes the second incident plane intersects the plane that includes the second output plane,
the oscillation member oscillates the second light transmission member in a direction in which the propagation length for which the light beam being previously incident on the second light transmission member travels through the second light transmission member changes, and
a guide is arranged to be parallel with the oscillation direction of the second light transmission member.

11. An image display device comprising: a light source adapted to emit a coherent light beam and the optical element as recited in any one of claims 8 to 10, the optical element being adapted to receive the light beam from the light source as the incident light beam.

12. An image display device comprising: light sources adapted to emit red, green, and blue light beams respectively, a dichroic mirror adapted to align the light beams from the light sources on the same optical path, a movable mirror adapted to make the light beams from the light sources scan, and the optical element as recited in any one of claims 8 to 10, the optical element being adapted to receive the light beams from the light sources as the incident light beam.

13. An optical element comprising:
a first light transmission member having a first incident plane on which a light beam is incident and a first output plane from which the light beam that was previously incident on the first incident plane is output;
a second light transmission member having a second incident plane on which the light beam output from the first light transmission member is incident and a second output plane from which the light beam that was previously incident on the second incident plane is output; and
an oscillation member adapted to oscillate the first light transmission member,
wherein:
the first light transmission member is arranged such that the plane that includes the first incident plane intersects the plane that includes the first output planed, and has a plane perpendicular to the first output plane,
the oscillation member is arranged on the plane perpendicular to the first output plane and oscillates the first light transmission member in the direction parallel with the first output plane, and
the second light transmission member is arranged such that the first output plane and the second incident plane are parallel.

14. An optical element comprising:
a first light transmission member having a first incident plane on which a light beam is incident and a first output plane from which the light beam that was previously incident on the first incident plane is output;
a second light transmission member having a second incident plane on which the light beam output from the first light transmission member is incident and a second output plane from which the light beam that was previously incident on the second incident plane is output; and
an oscillation member adapted to oscillate the second light transmission member,
wherein:
the second light transmission member is arranged such that the plane that includes the second incident plane intersects the plane that includes the second output plane, and has a plane perpendicular to the second output plane,
the oscillation member is arranged on the plane perpendicular to the second output plane and oscillates the second light transmission member in the direction parallel with the second output plane, and
the first light transmission member is arranged such that the first output plane and the second incident plane are parallel.

15. An image display unit comprising: a coherent light source, the optical element of claim 13 or 14 on which a light beam from the light source is incident, and a movable mirror adapted to vary the direction of the light beam emitted from the light source, wherein the movable mirror creates an image by varying the direction of the light beam output from the optical element.
